(19) United States
(12) Patent Application Publication
(10) Pub. No.: US 2009/0134192 A1
(43) Pub. Date: May 28, 2009

(54) MOUNTING ARRANGEMENT FOR A RETAINING STRAP OF A GAS TANK HOLDING DEVICE

(75) Inventor: Andreas Dossow, Bensheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, NI (unknown)

(21) Appl. No.: 12/253,033

(22) Filed: Oct. 16, 2008

(30) Foreign Application Priority Data
Oct. 18, 2007 (DE) 102007049837.5

(51) Int. Cl. B60R 9/00

(52) U.S. Cl. 224/400

(57) ABSTRACT

A mounting arrangement is provided for mounting a retaining strap for a gas tank of a gas tank holding device installed on a motor vehicle. The retaining strap is attached to the holding device with one end and mounted on the car body or the holding device such that it can be pivoted about at least one pivoting axis that extends perpendicular to the strap direction with its other end.

### CROSS-REFERENCE TO RELATED APPLICATION

This application claims priority to German Patent Application No. 102007049837.5, filed Oct. 18, 2007, which is incorporated herein by reference in its entirety.

### TECHNICAL FIELD

The present invention pertains to the field of automotive engineering, particularly to a mounting device for a retaining strap of a gas tank holding device of a motor vehicle, as well as to a corresponding holding device for a gas tank of a motor vehicle.

### BACKGROUND

In light of shrinking crude oil reserves and stricter requirements with respect to exhaust emissions, modern motor vehicles are increasingly equipped with internal combustion engines that operate in accordance with the four-stroke principle and are realized in the form of bivalent motor vehicles that can be selectively operated with gasoline or gaseous fuel. Currently, liquefied petroleum gas (LPG) and compressed natural gas (CNG) are predominantly used as the gaseous fuels.

Motor vehicles that can be operated with a gaseous fuel are equipped with a gas tank, in which the gaseous fuel can be stored in compressed form. In industrial series production, cylindrical steel cylinders are predominantly used as gas tanks because they are inexpensive and are very strong. In order to increase the range of these motor vehicles, the gas tank of a motor vehicle usually consists of several gas cylinders that are mounted on the bodywork (car body), usually on the vehicle floor or the undercarriage and/or on the main longitudinal beams or longitudinal frame beams. It is also known to mount the gas tank in a depression in the bottom of the luggage trunk that otherwise serves for accommodating the spare tire.

The gas cylinders are usually mounted on the bodywork with a special gas cylinder holding device that is mounted on the vehicle floor and/or the main longitudinal beams or the longitudinal frame beams. For this purpose, such gas cylinder holding devices are provided with sheet metal tubs (“cylinder supports”) that are adapted to the shape of the gas cylinders and on which flexible sheet metal strips (“retaining straps”) are mounted. The gas cylinders are placed on the cylinder supports and the retaining straps are subsequently mounted on the bodywork or on a beam of the holding device, and the retaining straps are tightened in such a way that they tightly adjoin the gas cylinders. In order to protect the gas cylinders against damages, the retaining straps are provided with suitable rubber pads. The gas cylinders are furthermore fastened to the cylinder supports with tension straps that are also provided with a suitable protective pad in order to fix and secure the gas cylinders in their position.

Conventional mounting arrangements for mounting retaining straps of a gas cylinder holding device as they are used by the applicant, for example, in production models of the series “Opel-Zafira” are described below with reference to FIG. 5 and FIG. 6.

The description initially refers to FIG. 5 that shows a first conventional mounting arrangement 100 for mounting a retaining strap on a car body. In this case, the retaining strap 101 in the form of a sheet metal strip is fixed on a cylinder support that is not illustrated in FIG. 5 with one end and on a car body part that forms part of the undercarriage such as, for example, an underbody crossmember 102 with its other end.

In order to mount the retaining strap 101, it is realized in the form of a loop 104 on its end that needs to be connected to the car body, namely by bending and fixing the sheet metal strip on itself in a flush fashion, for example, by means of welding. In addition, the loop 104 is provided with a slot 105 that originates at the end and extends in the strap direction, wherein this slot can be produced, for example, by punching the sheet metal strip prior to the bending process.

A locknut 107 with an internal thread is clamped on in a through-opening 109 of the underbody crossmember 102 in order to install the retaining strap 101. Subsequently, a bolt 103 with a not-shown through-bore is inserted into the loop 104 of the retaining strap 101 and a mounting screw 106 with an external thread is guided through the through-bore of the bolt 103 and through a not-shown through-bore of a spacer block 108 and subsequently screwed into the internal thread of the locknut 107 such that the retaining strap 101 is fixed on the underbody crossmember 102. The mounting screw 106 can be easily inserted through the slot 105 and tightened. The spacer block 108 serves for spacing apart the retaining strap 101 from the underbody crossmember 102 and also provides a contact surface 110 for the retaining strap 101 in the mounted position.

Prior to mounting the retaining straps on the car body with the aid of the first conventional mounting arrangement shown in FIG. 5, the gas cylinder holding device is installed on the vehicle and the gas cylinders are placed into the cylinder supports. Subsequently, the retaining straps are installed and tightened such that they tightly adjoin the gas cylinders in their final position.

FIG. 6 shows a second conventional mounting arrangement 200 for mounting a retaining strap 201 on a carrier 202 of the gas cylinder holding device installed on the vehicle. The retaining strap 201 is realized in the form of a sheet metal strip and attached to a cylinder support that is not illustrated in FIG. 6 with one end and mounted on the carrier 202 with the other end. Analogous to the first conventional mounting arrangement 100 illustrated in FIG. 5, the end of the retaining strap 201 to be mounted on the carrier 202 forms a loop 204 with a slot 205 arranged therein.

In order to mount the retaining strap 201 on the carrier 202, a bolt 203 with a not-shown through-bore is inserted into the loop 204 and a mounting screw 206 with an external thread is guided through the through-bore of the bolt 203 and screwed into the internal thread of a mounting block 207 that forms an integral part of the carrier 202. The mounting block 207 serves for screwing in the mounting screw 206, for spacing apart the retaining strap 201 from the carrier 202 and also provides a contact surface 208 for the retaining strap 201 in the mounted position.

One common aspect of both conventional mounting arrangements 100, 200 illustrated in FIG. 5 and FIG. 6 is that the retaining strap 101, 201 is respectively clamped on a contact surface 110, 208 of a spacer (spacer block 108 or mounting block 207) by means of a screw connection. However, practical experience has shown that a rigid connection between the retaining straps and these two spacers is disadvantageous because the gas cylinders are subjected to mechanical loads that significantly stress the retaining straps at the clamping points during the operation of the motor vehicle. This causes the retaining straps to be stressed, particularly in the form of a buckling stress perpendicular to the strap direction, and results in significant wear or even fracturing or tearing of the retaining straps.

It furthermore proved disadvantageous in industrial series production that the range of the installation tolerances occurring during the manufacture of gas cylinder holding devices and during their installation on the bodywork is relatively broad. Due to the final position that is predetermined by the contact surfaces of the retaining straps, a tolerance compensation cannot be realized during the installation of the retaining straps on the car body. This can have the disadvantageous effect that the mounting points of the retaining straps on the cylinder supports, as well as the mounting points of the cylinder supports on the gas cylinder holding devices (crossmembers), are subjected to stresses of different intensities. These stresses of different intensities can lead to structural damages of the respective mounting points.

This is the reason why the retaining straps should be checked within regular maintenance intervals, and this requires the vehicle to remain at the repair shop for a certain period of time and is associated with corresponding material and labor costs.

In view of the foregoing, at least one objective of the present invention is based on the objective of making available a mounting arrangement for a retaining strap of a gas cylinder holding device of a motor vehicle that is less susceptible to wear and malfunctions. In addition, other objectives, desirable features, and characteristics will become apparent from the subsequent summary and detailed description, and the appended claims, taken in conjunction with the accompanying drawings and this background.

### SUMMARY

According to an embodiment of the invention, this at least one objective, other objectives, features, and characteristics, is attained with a mounting arrangement for a retaining strap of a gas tank holding device of a motor vehicle. The embodiments of the invention disclose a mounting arrangement for mounting a retaining strap for a gas tank of a gas tank holding device installed on a motor vehicle.

The mounting arrangement includes, but is not limited to, a retaining strap attached to the holding device with one end and mounted on the car body or the holding device such that it can be pivoted about at least one pivoting axis that extend perpendicular to the strap direction with its other end. In this context, the term “strap direction” refers to the direction, in which the strap extends. The pivoted mounting of the retaining straps on the car body or the holding device advantageously makes it possible to prevent the buckling stress of the retaining strap perpendicular to the strap direction that occurs during the operation of the motor vehicle.

The pivoted mounting of the retaining strap on the car body or the holding device is advantageously realized in such a way that the retaining strap forms a loop on its end that is connected to the car body or the holding device, and a first (e.g., cylindrical) bolt that is connected to the car body or the holding device is accommodated in said loop such that it can be turned about its rotational axis. In this case, the loop is advantageously provided with a slot and the first bolt is screwed to the car body or the holding device by means of a mounting screw that extends through the first bolt and is arranged such that it is able to move within the slot during a pivoting motion of the first bolt.

In another advantageous embodiment of the mounting arrangement, the retaining strap is mounted on the car body of the motor vehicle or the holding device such that it can be pivoted about two parallel pivoting axes that extend perpendicular to the strap direction. This is advantageously realized in such a way that the first bolt is connected to a second (e.g., cylindrical) bolt that is mounted on the car body or the holding device and can be turned about its rotational axis. For this purpose, the second bolt is accommodated in a pivot bearing that is realized, for example, in the form of a bearing block or a sleeve and arranged on the car body or the holding device.

This makes it possible to prevent a buckling stress perpendicular to the strap direction of the retaining strap during the operation of the motor vehicle in a particularly reliable and dependable fashion.

The embodiments of the invention also pertain to a holding device for holding a gas tank of a motor vehicle that is equipped with the least one above-described mounting arrangement.

The embodiments of the invention furthermore pertain to a motor vehicle with at least one such holding device for holding a gas tank.

### BRIEF DESCRIPTION OF THE DRAWINGS

The present invention will hereinafter be described in conjunction with the following drawing figures, wherein like numerals denote like elements, and

FIG. 1 shows a perspective representation of a motor vehicle, in which one embodiment of an inventive holding device for a gas tank is illustrated in the form of a transparent view;

FIG. 2 shows a perspective representation of the gas tank holding device according to FIG. 1;

FIG. 3 shows a perspective exploded view of a first embodiment of an inventive mounting arrangement for mounting a retaining strap of the gas tank holding device according to FIG. 1;

FIG. 4 shows a perspective exploded view of a second embodiment of an inventive mounting arrangement for mounting a retaining strap of the gas tank holding device according to FIG. 1;

FIG. 5 shows a perspective representation of a conventional mounting arrangement for mounting a retaining strap of a gas cylinder holding device, and

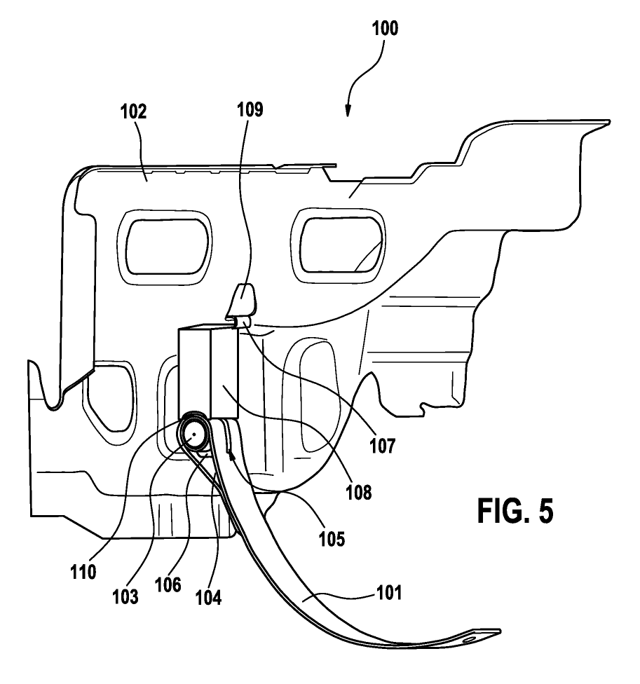

FIG. 6 shows a perspective representation of another conventional mounting arrangement for mounting a retaining strap of a gas cylinder holding device.

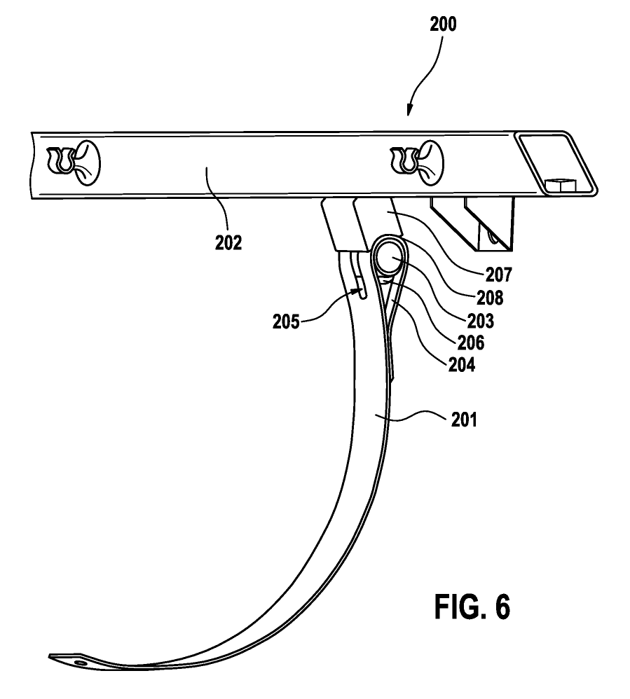

### DETAILED DESCRIPTION

The following detailed description is merely exemplary in nature and is not intended to limit application and uses. Furthermore, there is no intention to be bound by any theory presented in the preceding summary and background or the following detailed description.

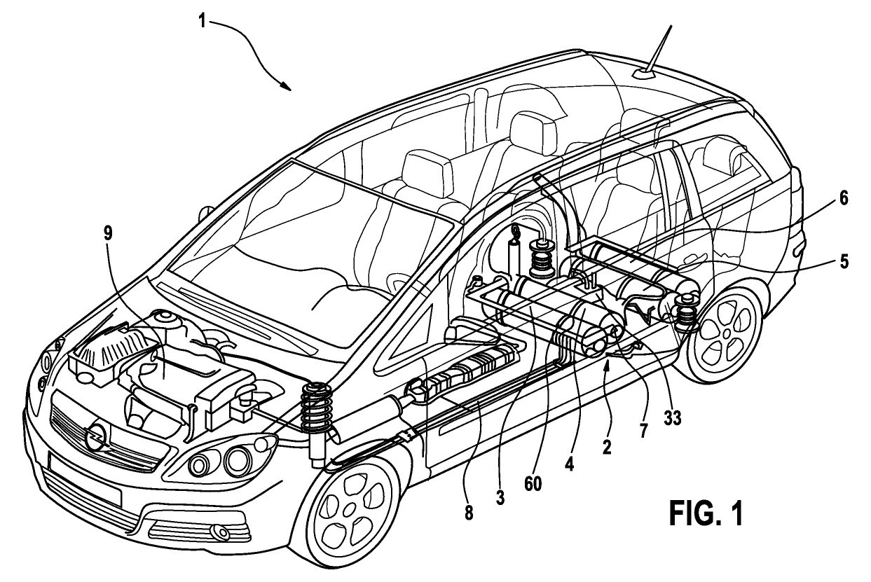

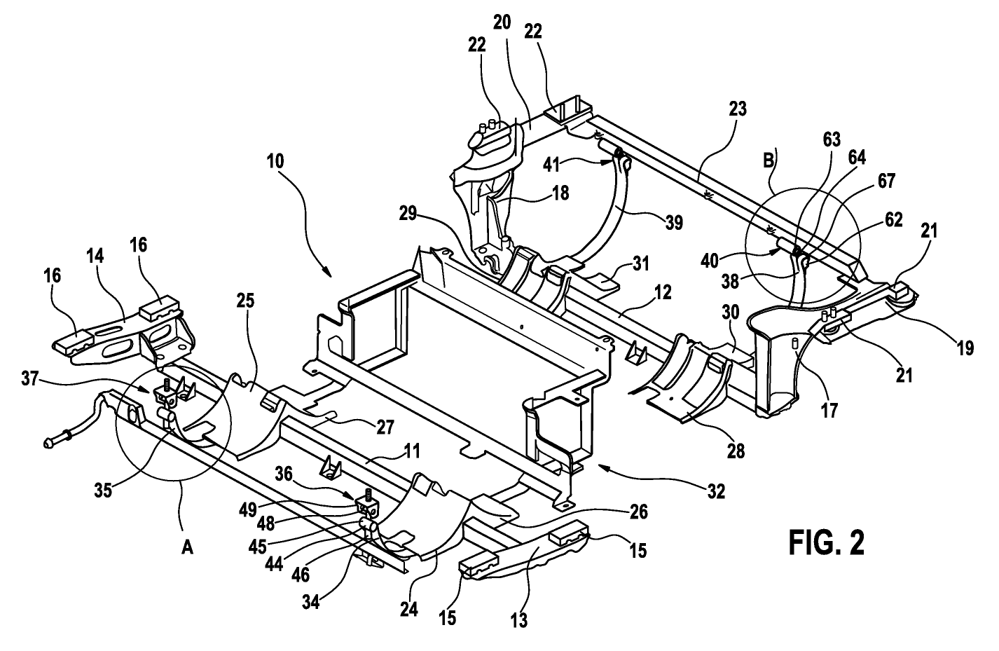

The description initially refers to FIG. 1 and FIG. 2 that show an embodiment of the inventive holding device for a gas tank of a motor vehicle.

FIG. 1 shows a perspective representation of a bivalent motor vehicle 1 that can be operated with gasoline and gaseous fuel, in this case compressed natural gas (CNG). A gas tank 2 that serves for storing gaseous fuel and a corresponding holding device 10 for the gas tank 2 are illustrated in the motor vehicle 1 in the form of a transparent view. The gas tank 2 comprises four gas cylinders 3-6 that are connected to one another in a fluidic (fluid-conducting) fashion. Gas valves 7 arranged on the respective gas cylinders 3-6 and gas lines 8 connected to these gas valves make it possible to feed CNG to an internal combustion engine 9 via a not-shown pressure regulator. A gasoline tank 33 is situated between the two front gas cylinders 3, 4 and the two rear gas cylinders 5, 6.

The gas cylinders 3-6 of the gas tank 2 and the gasoline tank 33 are mounted on the bodywork with the aid of the holding device 10 that is illustrated in greater detail in FIG. 2. The holding device 10 comprises a front crossmember 11 and a rear crossmember 12 that respectively extend transverse to the longitudinal direction of the vehicle and are realized in the form of cuboidal profiled components. Positional information such as front/rear and top/bottom and longitudinal/transverse refers to the installation position of the holding device 10 relative to the motor vehicle 1.

Front longitudinal beams 13, 14 that extend in the longitudinal direction of the vehicle are mounted on both ends of the front crossmember 11 and respectively provided with front mounting elements 15, 16 for mounting the front longitudinal beams 13, 14 on the car body (in this case, for example, the undercarriage) of the motor vehicle 1. Vertically extending columns 17, 18 are mounted on both ends of the rear crossmember 12, and rear longitudinal beams 19, 20 extending in the longitudinal direction of the motor vehicle are respectively attached to the aforementioned columns. The rear longitudinal beams 19, 20 are respectively provided with rear mounting elements 21, 22 for screwing the longitudinal beams 19, 20 to the car body (in this case, for example, the main longitudinal beams) of the motor vehicle 1. In addition, a cross brace 23 (“supporting brace”) that extends in the transverse direction of the vehicle is mounted on both rear longitudinal beams 19, 20.

Two cylinder holders in the form of four tub-shaped cylinder supports are attached to the front crossmember 11, namely two cylinder supports 24, 25 that are directed forward and two cylinder supports 26, 27 that are directed rearward. Analogously, two cylinder holders in the form of four cylinder supports are attached to the rear crossmember 12, namely two cylinder supports 28, 29 that are directed forward and two cylinder supports 30, 31 that are directed rearward.

A support construction that is identified as a whole by the reference numeral 32 and serves for accommodating the gasoline tank 33 is mounted on the two rearwardly directed cylinder supports 26, 27 of the front crossmember 11.

A front retaining strap 34, 35 in the form of a sheet metal strip is respectively welded to both forwardly directed cylinder supports 24, 25 of the front crossmember 11. The front retaining straps 34, 35 are mounted on the car body of the motor vehicle by means of front mounting arrangements that are respectively identified as a whole by the reference numerals 36 and 37. A rear retaining strap 38, 39 is respectively welded to both rearwardly directed cylinder supports 30, 31 of the rear crossmember 12. The rear retaining straps 38, 39 are mounted on the supporting brace 23 by means of rear mounting arrangements that are respectively identified as a whole by the reference symbols 40 and 41.

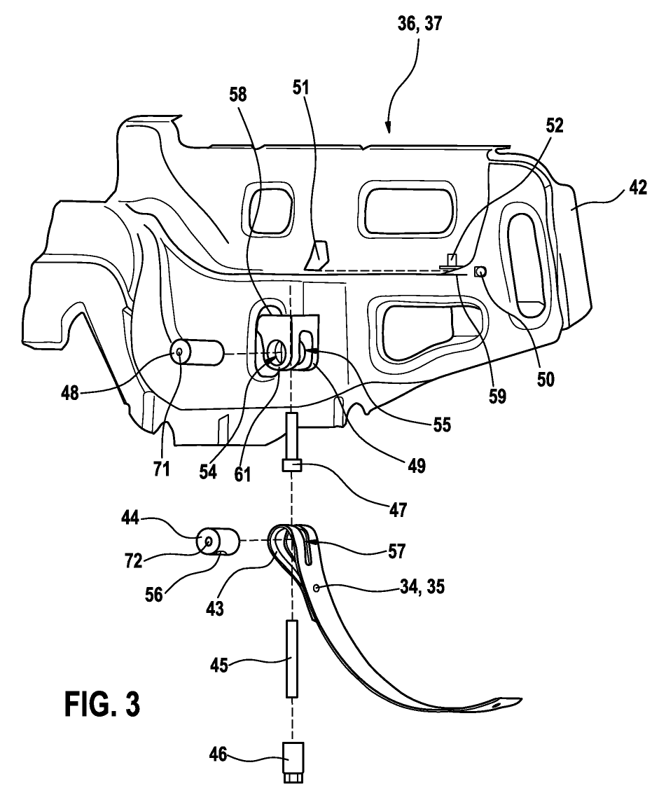

FIG. 3 shows a detail of the front mounting arrangement 36, 37 for mounting the front retaining straps 34, 35 on the bodywork that corresponds to the circle A in FIG. 2. The front retaining straps 34, 35 are not mounted until the holding device 10 is installed on the car body by means of the front mounting elements 15, 16 and the rear mounting elements 21, 22.

According to FIG. 3, the front mounting arrangement 36, 37 comprises the front retaining strap 34, 35 that is welded to the forwardly directed cylinder support 24, 25 of the front crossmember 11 with one end and mounted on a car body component of the undercarriage of the motor vehicle 1, in this case, for example, the underbody crossmember 42, with its other end.

The end of the front retaining strap 34, 35 to be connected to the underbody crossmember 42 is provided with a loop 43 that is produced by bending and welding the sheet metal strip to itself in a flush fashion. In addition, the loop 43 is provided with a slot 57 that originates at the end and extends in the strap direction, and the slot can be produced by means of punching prior to bending the sheet metal strip.

In order to install the front retaining strap 34, 35, a locknut 50 with an internal thread 52 is clamped on in a through-opening 51 of the underbody crossmember 42. Subsequently, a screw 47 with an external thread is guided through a not-shown through-opening of a bearing block 49 and screwed into the internal thread of the locknut 50 such that an upper contact surface 58 of the bearing block 59 comes in contact with a lower contact surface 59 of the locknut 50 and the bearing block 49 is rigidly mounted on the underbody crossmember 42.

The bearing block 49 features two limb sections 61 that oppose one another and are respectively provided with a round through-bore 54. A recess 55 is situated between the two limb sections 61.

Subsequently, a cylindrical bearing block bolt 48 is inserted into the two through-bores 54 of the bearing block 49 that serve for rotatably supporting the bearing block bolt 48. For this purpose, the diameter of the respective through-bores 54 is larger than the diameter of the bearing block bolt 48 such that the bearing block bolt 48 can be turned about its rotational (cylinder) axis 71 that is directed perpendicular to the direction, in which the strap extends. The bearing block bolt 48 is provided with a pocket hole 53 with an internal thread, wherein the bearing block bolt 48 is initially positioned within the through-bores 54 of the bearing block 49 such that the blind pocket 53 points downward.

Subsequently, a cylindrical loop bolt 44 provided with a through-bore 56 is inserted into the loop 43 of the retaining strap 34, 35. The loop 43 has such dimensions that the loop bolt 44 is able to turn about its rotational (cylinder) axis 72 that is directed perpendicular to the direction, in which the strap extends. A stud bolt 45 with an external thread is pushed through the slot 57 from the bottom and then through the through-bore 56 of the loop bolt 44, and this stud bolt is subsequently screwed into the internal thread of the pocket hole 53 of the bearing block bolt 48, and a clamping nut 46 is screwed on the stud bolt 45 for this purpose. The stud bolt is only tightened to such a degree that the retaining strap 34, 35 is not clamped to the bearing block 49. For example, a clearance (play) of a few millimeters remains between the screwed-on end of the retaining strap 34, and the bearing block 49.

The mounting arrangement according to FIG. 3 therefore enables the front retaining strap 34, 35 to pivot about the rotational axis 71 of the bearing block bolt 48 that is oriented perpendicular to the strap or strip direction of the front retaining strap 34, 35. The stud bolt 45 screwed to the bearing block bolt 48 is able to move freely within the recess 55 of the bearing block 49 during a pivoting motion of the bearing block bolt 48. It also enables the front retaining strap 34, 35 to pivot about the rotational axis 72 of the loop bolt 56 that is oriented perpendicular to the strap or strip direction of the front retaining strap 34, 35. The stud bolt 45 extending through the loop bolt 56 is able to move freely within the slot 57 in the loop 43 of the front retaining strap 34, 35 during a pivoting motion of the loop bolt 56.

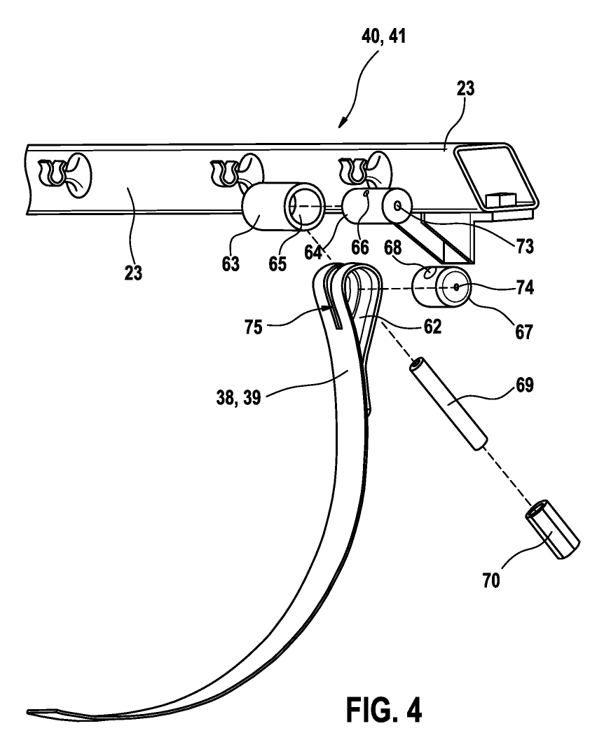

FIG. 4 shows a detail of the rear mounting arrangement 40, 41 for mounting the rear retaining straps 38, 39 on the supporting brace 23 that corresponds to the circle B in FIG. 2. The rear retaining straps 38, 39 are mounted after the installation of the holding device 10 on the car body of the motor vehicle 1 by means of the front mounting elements 15, 16 and the rear mounting elements 21, 22.

According to FIG. 4, the rear mounting arrangement 40, 41 comprises the rear retaining straps 38, 39 that are welded to the cylinder supports 30, 31 with one end and mounted on the supporting brace 23 of the holding device 10 with their other end.

The end of the rear retaining straps 38, 39 to be mounted on the supporting brace 23 is provided with a loop 62 that is produced by bending and welding the sheet metal strip in a flush fashion. In addition, the loop 62 is provided with a slot 75 that originates at the end and extends in the direction of the sheet metal strip.

The supporting brace features an integral hollow-cylindrical sleeve 63 for the installation of the rear retaining strap 38, 39, and this can be realized, for example, by welding a sleeve 63 to the supporting brace 23. It would also be possible to realize the supporting brace 23 and the sleeve 63 in one piece.

In order to install the rear retaining strap 38, 39, a sleeve bolt 64 is initially inserted into the sleeve 63 of the supporting brace 23. The inside diameter of the sleeve 63 is slightly larger than the outside diameter of the sleeve bolt 64 such that the sleeve bolt 64 is able turn about its rotational (cylinder) axis 73 in the sleeve 63. The sleeve bolt 64 is provided with a pocket hole 66 with an internal thread. The installation is realized by positioning the sleeve bolt 64 within the sleeve 63 in such a way that the pocket hole 66 overlaps with a slot-shaped through-opening 65 of the sleeve 63.

Subsequently, a loop bolt 67 with a through-bore 68 is inserted into the loop 62 of the retaining strap 38, 39. The loop 62 has such dimensions that the loop bolt 67 is able to turn about its rotational (cylinder) axis 74. A stud bolt 69 with an external thread is pushed through the slot 75 from the bottom and then through the through-bore 68 of the loop bolt 67, and this stud bolt is subsequently screwed into the internal thread of the pocket hole 66 of the sleeve bolt 64, and wherein a clamping nut 70 is screwed on the stud bolt 69 for this purpose. The stud bolt 69 is only tightened to such a degree that the retaining strap 38, 39 is not clamped to the sleeve 63. For example, a clearance (play) of a few millimeters remains between the screwed-on end of the retaining strap 38, 39 and the sleeve 63.

The mounting arrangement according to FIG. 4 thusly enables the rear retaining straps 38, 39 to pivot about the rotational axis 73 of the sleeve bolt 64 that is oriented perpendicular to the strap or strip direction of the rear retaining strap 38, 39. The stud bolt 69 screwed to the sleeve bolt 64 is able to move freely within the slot-shaped through-opening 65 of the sleeve 64 during a pivoting motion of the sleeve bolt 64. It also enables the rear retaining strap 38, 39 to pivot about the rotational axis 74 of the loop bolt 67 that is oriented perpendicular to the strap or strip direction of the rear retaining strap 38, 39. The stud bolt 69 extending through the loop bolt 67 is able to move freely within the slot 75 in the loop 62 of the rear retaining strap 38, 39 during a pivoting motion of the loop bolt 67.

In order to install the gas cylinders 3-6 of the gas tank 2, the two front gas cylinders 3, 4 are placed on the two forwardly directed cylinder supports 24, 25 and the two rearwardly directed cylinder supports 26, 27 of the front crossmember 11 transverse to the longitudinal direction of the vehicle, and the two front retaining straps 34, 35 are respectively mounted on the underbody crossmember 42 by means of a front mounting arrangement 36, 37 according to FIG. 3. Accordingly, the two rear gas cylinders 5, 6 are placed on the two forwardly directed cylinder supports 28, 29 and the two rearwardly directed cylinder supports 30, 31 of the rear crossmember 12 transverse to the longitudinal direction of the vehicle, and the two rear retaining straps 38, 39 are respectively mounted on the supporting brace 23 by means of a rear mounting arrangement 40, 41 according to FIG. 4.

The two front retaining straps 34, 35 are alternately tightened on the left/right side until a desired tightening torque is reached. Analogously, the two rear retaining straps 38, 39 are alternately tightened on the left/right side until a desired tightening torque is reached. In the mounted state, the front retaining straps 34, 35 and the rear retaining straps 38, 39 respectively should tightly adjoin the gas cylinders. A vertical tolerance compensation during the installation can be realized due to the ability to vary the tightening of the retaining straps in the two mounting arrangements.

In addition, the two front gas cylinders 3, 4 and the two rear gas cylinders 5, 6 are respectively clamped to one another by means of tension straps 60.

The embodiments for the mounting arrangements for the retaining straps of a gas tank holding device of a motor vehicle make it possible to respectively pivot the retaining straps about pivoting axes that are oriented vertically referred to the strap or strip direction such that a buckling stress can be advantageously prevented at the connecting point of the retaining strap on the car body or the holding device, and this reduces the wear and prevents the retaining straps from fracturing or tearing. In addition, the inventive mounting arrangements advantageously allow a tolerance compensation during the installation.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A mounting arrangement for mounting a gas tank to a body of a motor vehicle, comprising:
a holding device for the gas tank; and
a retaining strap attached to the holding device with a first end mounted to pivot about a pivoting axis extending substantially perpendicular to a direction of the retaining strap with a second end.

2. The mounting arrangement according to claim 1, wherein the retaining strap is mounted to pivot about two parallel pivoting axes that extend substantially perpendicular to the direction.

3. The mounting arrangement according to claim 1, further comprising a tub-shaped profiled component attached to the retaining strap that is adapted to hold the gas tank.

4. The mounting arrangement according to claim 1, wherein the retaining strap forms a loop on the second end and a first bolt is accommodated in the loop such that it can be turned about a rotational axis.

5. The mounting arrangement according to claim 4, wherein the loop is provided with a slot and the first bolt is attached to at least one of the body or the holding device with a mounting screw that extends through the first bolt and is arranged for movement within the slot during a pivoting motion of the first bolt.

6. The mounting arrangement according to claim 4, wherein the first bolt is connected to a second bolt mounted on at least one of the body or the holding device and adapted to turn about the rotational axis.
